(19) United States
(12) Patent Application Publication
(10) Pub. No.: US 2021/0171399 A1
(43) Pub. Date: Jun. 10, 2021

(54) CAST MOLD FORMING COMPOSITIONS AND USES THEREOF

(71) Applicant: ECONCRETE TECH LTD., Tel Aviv (IL)

(72) Inventors: IDO SELLA, Tel Aviv (IL); Shimrit FINKEL, Tel Aviv (IL)

(73) Assignee: ECONCRETE TECH LTD., Tel Aviv (IL)

(21) Appl. No.: 17/267,859

(22) PCT Filed: Aug. 14, 2019
(86) PCT No.: PCT/IL2019/050912

§ 371 Date: Feb. 11, 2021

Related U.S. Application Data
(60) Provisional application No. 62/718,407, filed on Aug. 14, 2018.

(51) Int. Cl. C04B 28/18; C04B 28/02; B28B 1/26; B28B 7/34

(52) U.S. Cl. CPC C04B 28/18; C04B 28/02; C04B 2111/00939; B28B 7/342; B28B 7/346; B28B 1/262

(57) ABSTRACT

The present invention provides a composition for forming a casting mold or a mold liner, comprising solid particles of CaO, SiO, MgO, Al₂O₃ having an average particle size of 20 to 60 μm.

### BACKGROUND OF THE INVENTION

Casting is a manufacturing process in which a liquid material is usually poured into a mold, which contains a hollow cavity of the desired shape, and then allowed to solidify. The solidified part is also known as a casting, which is ejected or broken out of the mold to complete the process.

Plaster and other chemical curing materials such as concrete and polymers and plastic resin may be cast using single-use waste molds, multiple-use ‘piece’ molds, or molds made of small rigid pieces or of flexible material such as latex rubber (which is in turn supported by an exterior mold).

Molding is the process of manufacturing by shaping liquid or pliable raw material using a rigid frame called a mold or matrix. This itself may have been made using a pattern or model of the final object.

A mold is a hollowed-out block that is filled with a liquid or pliable material such as concrete. The liquid hardens or sets inside the mold, adopting its shape. A mold is the counterpart to a cast. The very common bi-valve molding process uses two molds, one for each half of the object. Articulated molds have multiple pieces that come together to form the complete mold, and then disassemble to release the finished casting; they are expensive, but necessary when the casting shape has complex overhangs.

One of the drawbacks of the casting mold process is the part where the cast is released from the mold. This stage of the process usually requires either impart (breaking down the mold) or using some type of a release agent. Breakage of the cast product is typically experienced making the profitability of this process limited. There is therefore an outstanding need to provide cast molds that are made of affordable materials, which can be easily broken down when releasing the cast.

### SUMMARY OF THE INVENTION

The invention provides a composition comprising solid particles of CaO, SiO, MgO, Al₂O₃ wherein the average particle size of said solid particles is between about 20 μm to 60 μm.

In some embodiments, said CaO is in the amount of at least 30% wt of the composition. In some embodiments, said MgO is in the amount of at least 0.5% wt of the composition. In some embodiments, said SiO is in the amount of at least 0.5% wt of the composition. In some embodiments, said Al₂O₃ is in the amount of at least 0.5% wt of the composition. In some embodiments, said CaO is in the amount of between about 30% to 60% wt of the composition. In some embodiments, said MgO is in the amount of between about 0.5% to 20% wt of the composition. In some embodiments, said SiO is in the amount of between about 0.5% to 5.5% wt of the composition. In some embodiments, said Al₂O₃ is in the amount of between about 0.5% to 1.5% wt of the composition.

In some embodiments, said composition of the invention further comprises at least one of Fe₂O₃, TiO₂, K₂O, Na₂O, P₂O₅, Mn₂O₃ and SO₃ and any combinations thereof.

The invention further provides a composition comprising solid particles of CaO, SiO, MgO, Al₂O₃ wherein the average particle size of said solid particles is between about 20 μm to 60 μm, for use in the preparation of a casting mold.

In some embodiments, said casting mold is a curable material casting mold. In other embodiments, said casting mold is a mold-liner. In further embodiments, said casting mold of the invention can be degraded or broken down by washing it with water.

When referring to “curable material” it should be understood to encompass any material that becomes hardened, as compared with its pre-curable form, upon exposure to a curing process, including, but not limited to, heat, pressure, steam, additives, energy (UV, IR, microwave, X-ray and so forth), radiation, vulcanization and so forth or any combinations thereof. During the curing process, the material hardens due to internal processes that change the physical and/or chemical properties, such processes include, but are not limited to: formation of cross-linking bonds, loss of water (dehydration), reducing the space between the polymer chains of the material and so forth.

Examples of curable materials include concrete, resins, polymers, thermosetting polymers, thermoplastic polymers, plaster and so forth, and any combinations thereof. In some embodiments, said curable material is concrete.

When referring to the breaking down of the casting mold made of a composition of the invention, it should be understood to relate to the disintegration of the casting mold so as to break it to parts and remove it from the casted cured material within it. The breaking down is performed using water.

The invention further provides a casting mold comprising a composition comprising solid particles of CaO, SiO, MgO, Al₂O₃ wherein the average particle size of said solid particles is between about 20 μm to 60 μm.

The invention further provides a mold-liner comprising a composition comprising solid particles of CaO, SiO, MgO, Al₂O₃ wherein the average particle size of said solid particles is between about 20 μm to 60 μm.

The invention further provides a method of forming a casting mold comprising the steps of: (a) providing a composition comprising solid particles of CaO, SiO, MgO, Al₂O₃ wherein the average particle size of said solid particles is between about 20 μm to 60 μm; (b) mixing said composition with water so as to form a pliable wet mixture; (c) forming a 3 dimensional mold from said wet mixture; (d) drying said mold so as to form a dry casting mold.

The invention further provides a method of forming a curable material cast product comprising the steps of: (a) providing a casting mold having an empty cavity in the form of said product; said casting mold comprising a composition comprising solid particles of CaO, SiO, MgO, Al₂O₃ wherein the average particle size of said solid particles is between about 20 μm to 60 μm; (b) filling said casting mold with pre-cured material; (c) curing said material in said filled casting mold; (d) washing said casting mold with water so as to breakdown said casting mold; thereby receiving said cast product.

The invention further provides a method of forming a patterned curable material product comprising the steps of: (a) providing a pattern forming composition comprising solid particles of CaO, SiO, MgO, Al₂O₃ wherein the average particle size of said solid particles is between about 20 μm to 60 μm; (b) mixing said pattern forming composition with water so as to form a pliable wet mixture; (c) applying said pattern forming composition on a curable material casting mold; (d) letting said pattern forming composition dry so as to form a patterned casting mold; (e) filling said patterned casting mold with a pre-curable material; (c) curing said material in said filled patterned casting mold; (d) washing said pattern composition with water so as to break it down; thereby receiving said patterned product.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows how the composition of the invention is sprayed to a surface of a molding cast.

FIGS. 2A-2B show a cast mold after spraying with a composition of the invention.

FIGS. 3A-3B shows the cured units after stripping of molds. (See concrete unit with (TOP) and without (BOTTOM) application of the composition).

FIGS. 4A-4B shows cured units after washing the composition with water off the cured concrete surface. TOP: concrete unit with (LEFT) and without (LOWER RIGHT) application of the composition of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

### Example 1

1. The dry composition of the invention is mixed with tap water to the required consistency. For spraying the composition more water is added while for molding the composition (like clay) less water is required.

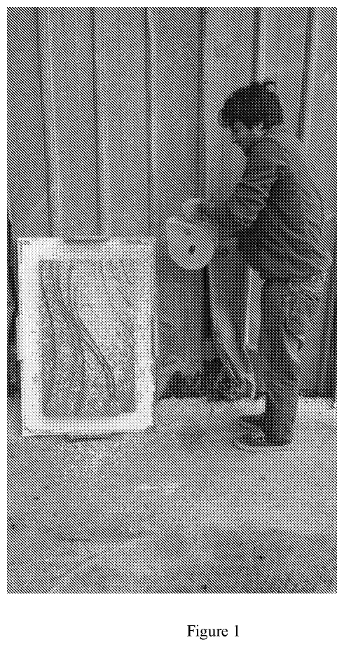

2. The composition is sprayed on the surface of the mold (FIG. 1) or attached to it (in the clay consistency).

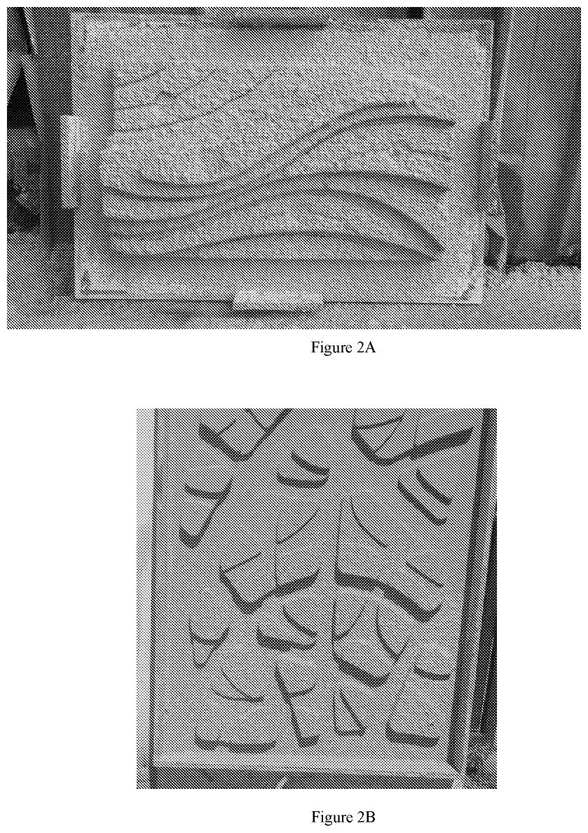

3. The composition dries on the surface of the mold, or in clay consistency (before the attaching to the mold) for minutes to hours depending on the air temperature (20 min to 1 hour in 30 C, depending on the thickness of the composition) (FIG. 2).

4. Concrete is cast in the molds on top the applied composition.

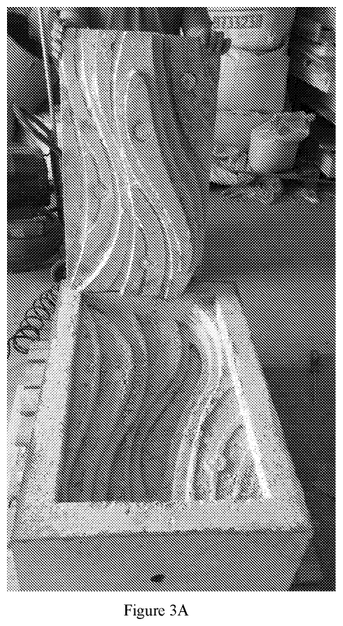

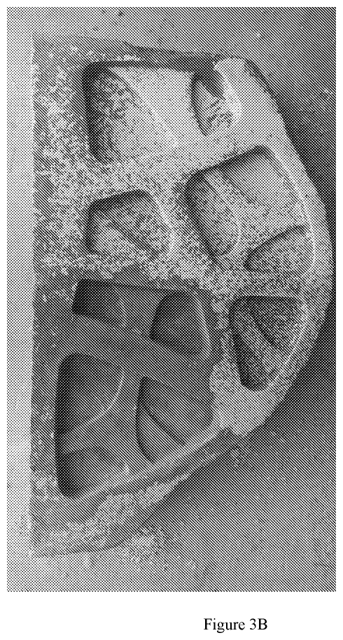

5. After curing, the molds are stripped, and the pattern formed by the composition of the invention can be noted on the surface of the concrete that was in contact with the mold (FIG. 3)

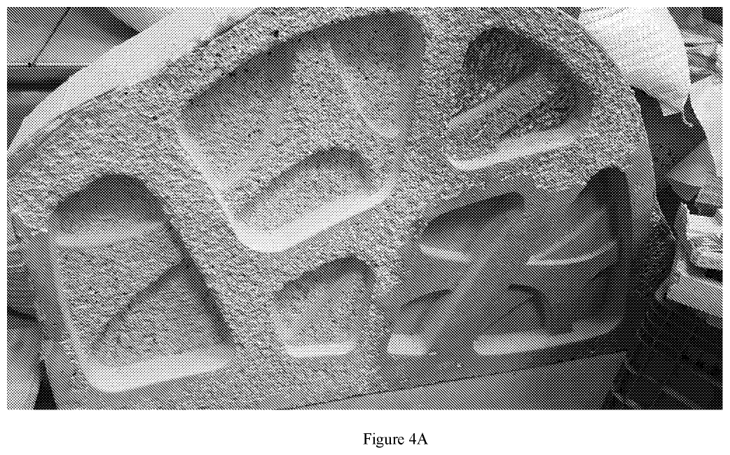

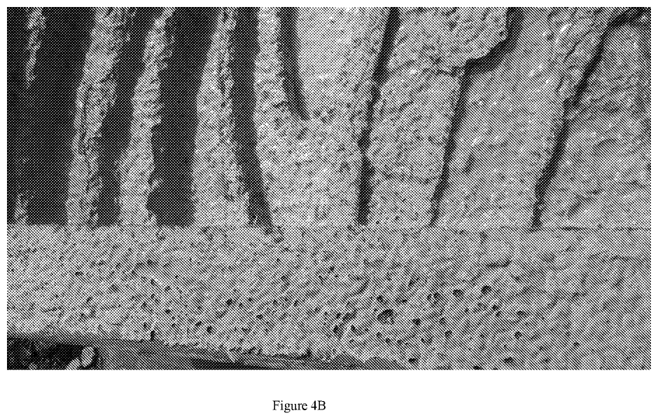

6. Tap water was used to dissolve the composition from the concrete face, leaving the pattern, voids and spaces on the cured concrete surface (FIG. 4)

7. The water with the dissolved composition can be captured and trough evaporation or separation the composition can be used again.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A composition comprising solid particles of CaO, SiO, MgO, Al₂O₃ wherein the average particle size of said solid particles is between about 20 μm to 60 μm, wherein said composition is a casting mold composition.

2. (canceled)

3. A composition of claim 1, wherein said CaO is in the amount of at least 30% wt of the composition.

4. A composition of claim 1, wherein said MgO is in the amount of at least 0.5% wt of the composition.

5. A composition of claim 1, wherein said SiO is in the amount of at least 0.5% wt of the composition.

6. A composition of claim 1, wherein said Al₂O₃ is in the amount of at least 0.5% wt of the composition.

7. A composition of claim 1, wherein CaO is in the amount of between about 30% to 60% wt of the composition.

8. A composition of claim 1, wherein said MgO is in the amount of between about 0.5% to 20% wt of the composition.

9. A composition of claim 1, wherein said SiO is in the amount of between about 0.5% to 5.5% wt of the composition.

10. A composition of claim 1, wherein said Al₂O₃ is in the amount of between about 0.5% to 1.5% wt of the composition.

11. A composition of claim 1, further comprising at least one of Fe₂O₃, TiO₂, K₂O, Na₂O, P₂O₅, Mn₂O₃ and SO₃ and any combinations thereof.

12. A composition of claim 1, wherein said casting mold is a curable material casting mold.

13. A composition of claim 1, wherein said casting mold is a mold-liner.

14. (canceled)

15. (canceled)

16. A method of forming a casting mold comprising the steps of: (a) providing a composition comprising solid particles of CaO, SiO, MgO, Al₂O₃ wherein the average particle size of said solid particles is between about 20 μm to 60 μm; (b) mixing said composition with water so as to form a pliable wet mixture; (c) forming a 3 dimensional mold from said wet mixture; (d) drying said mold so as to form a dry casting mold.

17. (canceled)

18. (canceled)
